(19) United States
(12) Patent Application Publication
(10) Pub. No.: US 2004/0039716 A1
(43) Pub. Date: Feb. 26, 2004

(54) System and method for optimizing a computer program

(76) Inventor: Dean S. Thompson, Ligonier, PA (US)

Correspondence Address: IP Department, Schnader Harrison Segal & Lewis, 36th Floor, 1600 Market Street, Philadelphia, PA, 19103, US

(21) Appl. No.: 10/645,982

(22) Filed: Aug. 22, 2003

Related U.S. Application Data
(60) Provisional application No. 60/405,679, filed on Aug. 23, 2002.

(51) Int. Cl. G06F 15/18

(52) U.S. Cl. 706/13

(57) ABSTRACT

A method and system for constructing a computer program that solves a problem is disclosed. The invention includes defining a set of traits in which each trait characterizes a portion of a solution algorithm to the problem and defining a programming interface for at least one of the traits. The invention further includes providing an implementation for at least one of the defined programming interfaces. A subtrait associated with at least one of the traits or the implementations is specified and a top-level trait is selected that characterizes a solution to the problem. In addition, a top-level implementation for the top-level trait is selected along with an implementation for each subtrait required for the top-level trait or the top-level implementation. Lastly, an implementation for each subtrait associated with at least one of the traits or the implementations is recursively selected in order to construct a trait hierarchy that forms a computer program for solving the problem.

### FIELD OF THE INVENTION

The invention relates to object oriented programming, and in particular, a method for optimizing a computer algorithm.

### BACKGROUND OF THE INVENTION

Modem programming environments have sought to make software components replaceable at run time. Part of the theory behind object oriented languages such as C++ and Java is that software can be encapsulated in classes and reused by multiple programs. A given program can also be modified to use alternative classes, so long as each alternative class implements the same interface.

Unfortunately, most programming languages and environments do not allow a human user or an optimization algorithm to change a program by swapping in alternative implementations of an interface. For example, in C++, the name of the class that will provide the implementation of an interface must be hard-coded at some point in the program.

More recent environments have provided solutions to this problem. Microsoft's ActiveX components, for example, define exported interfaces that can be replaced at runtime. Java provides support for a pluggable interface, in which a text file called a properties file is updated at installation time to provide the name of the class that will implement a particular interface.

While these environments allow certain portions of a program to be replaced by programmers, they do not provide a general technique for non-programmers to replace portions of a program. One reason for this is that the alternative class implementations themselves do not contain descriptive information to allow a non-programmer to identify the components required for a useful program. Techniques such as ActiveX components or pluggable Java interfaces are also not suitable for the construction of an entire program; they are used only for small portions of a program or for joining major modules.

In order to create programs in which every component is replaceable by programmers and non-programmers alike, the structure of the program would have to be inherent in the components themselves. Each component would itself specify in a clear, accessible way the functionality that it provides, the interface that it implements, and the subordinate interfaces that it requires.

One research area where the replacement of program components has been studied in detail is that of algorithm optimization and search techniques. Such research seeks to represent candidate solutions to a given problem in a well-defined format, and then modify the candidate solutions to produce an optimal solution to the problem. In essence, this is the same process as representing computer programs in a programming language and then modifying computer programs to produce more useful ones. As a result, the research on solution optimization is a good place to look for techniques that might apply to modular replacement of software components.

Optimization and search techniques are broadly classified into two sets: “strong methods” and weak methods.” Strong methods are those that take advantage of the unique characteristics of a specific problem. For example, successful chess-playing programs are constructed largely from strong methods. Weak methods are those that can be applied to broad classes of problems. Depth-first tree search is a simple example of a weak method.

In their 1989 article “Using Genetic Algorithms to Solve NP-Complete Problems,” [De Jong, Spears 1989] De Jong and Spears observe: “Generally, a weak method is one which has the property of wide applicability but, because it makes few assumptions about the problem domain, can suffer from combinatorially explosive solution costs when scaling up to larger problems.” They go on to explain that strong methods have their own difficulties: “The difficulty with strong methods, of course, is their limited domain of applicability leading, generally, to significant redesign even when applying them to related problems.”

The spectrum between weak and strong methods represents a severe dilemma for those who wish to implement practical systems. It has been proven that some knowledge of the problem domain must be used in order to devise an effective optimization or search method. This is shown by the “No Free Lunch” theorem of Wolpert and Macready [Wolpert, Macready 1995], which states that all optimization and search methods in fact have the same (poor) average performance when averaged across all problems. However, if computer software is to be routinely applied to a wide range of problems, techniques must be found that can be reused in different domains with a minimum of redesign and re-implementation.

In light of this dilemma, considerable excitement and energy has been generated by algorithms that promise to solve broad classes of problems with acceptable levels of redesign and reimplementation. As De Jong and Spears state: “. . . it is becoming increasingly clear that there are at least two methodologies which fall in between these two extremes and offer in similar ways the possibility of powerful, yet general problem solving methods. The two approaches we have in mind are Genetic Algorithms (GAs) and Neural Networks (NNs). They are similar in the sense that they achieve both power and generality by demanding that problems be mapped into their own particular representation in order to be solved.”

The central challenge for optimization techniques like genetic algorithms and neural networks is the challenge of finding a good mapping from candidate solutions to the representation required by the optimization technique. A suitable mapping must be found for each problem that is to be solved. To quote from De Jong and Spears again, “If a fairly natural mapping exists, impressive robust performance results. On the other hand, if the mapping is awkward and strained, both approaches behave much like the more traditional weak methods yielding mediocre, unsatisfying results when scaling up.” A representation is needed that is suitable for optimization, but that has a natural mapping to the solutions for each target problem.

In spite of this requirement for good representations, little progress has been made in exploring alternative representations for candidate solutions. The existing work in genetic algorithms provides a good example. Typically, candidate solutions for genetic algorithms are represented as strings of characters in a well-defined representation language. As a simplistic example, a driving directions program might represent a solution for driving from point A to point B as a sequence of characters for each intersection encountered, where L represents a left turn, R a right turn, and S indicates to proceed straight ahead. In this representation, a solution “LSR” would call for turning left at the first intersection, going straight at the second intersection, and turning right at the third intersection. The representation language can be thought of as a programming language, and a specific representation (in this case, “LSR”) as a program written in the language.

More specifically, candidate solutions in the most common form of genetic algorithm (as presented by John Holland [Holland 1975]) are sequences of values called “attributes.” Each sequence of attributes represents a solution to a problem. An initial set, or “population,” of solutions is established. A program evaluates the performance, or fitness, of each solution. It then attempts to find an optimal solution by progressively deriving better performing, or more fit, solutions to the problem. The derivation of new solutions from existing solutions is performed through one or more well-defined transformations, which are referred to as the “genetic operations.” For example, Holland studied “crossover” as a genetic operation. To perform the crossover operation, two existing solutions are chosen, and their attribute sequences are aligned side-by-side. One position in the attribute sequence is chosen as the “crossover point.” A single new solution is then created. The attribute sequence for this new solution is created by drawing from one of the existing solutions until the crossover point, and then drawing from the other existing solution after the crossover point.

The original argument for the effectiveness of such genetic algorithms relied on having certain attribute combinations, called “schemata” or “schema,” that increase the average fitness of candidate solutions in which they are present. The importance of a given schema in the progress of the algorithm depends on the schema's survivability under the genetic operations used. In the case of crossover, for example, this survivability depends on the schema's length relative to the total length of the candidate solution.

Of course, the success of a genetic algorithm depends both on the selected representation format and the genetic operations that are used to create new candidate representations. The likely success of a particular algorithm is often analyzed by studying the “fitness landscape.” The fitness landscape is the surface formed by plotting the relative fitness of all possible candidate solutions against the n-dimensional space formed by incrementally modifying candidate solutions through the genetic operations. The “ruggedness” of this landscape measures the correlation between fitness values at nearby points in the space of candidate solutions. A highly rugged fitness landscape makes it difficult for an optimization algorithm to perform better than a random search of candidate solutions.

An alternative way of examining fitness landscape ruggedness was envisioned by Bernhard Sendhoff [Sendhoff et. al. 1997]. They introduced the term “strong causality” as follows: “The optimisation process in evolutionary algorithms is largely influenced by the mapping from the genotype space [the space of possible representations] to the phenotype space [the fitness landscape]. Especially for structure optimisation problems a measure of the quality of the combination (mapping, mutation, crossover) would be desirable. In this paper we propose such a measure . . . We demand that the search process is locally strongly causal with respect to the mutation operator, that is: small variations on the genotype space due to mutation imply small variations in the phenotype space.” The idea behind strong causality is that when an incremental change is made to the representation of a candidate solution (corresponding to the genotype), this should result in an incremental change to the behavior of the candidate solution (corresponding to the phenotype).

A final term useful in evaluating a selected representation is “epistasis,” a term borrowed from research in natural genetics. Epistasis in natural genetics refers to the blocking of one gene by another gene. More generally, epistasis is the idea of non-additive interactions across many genes, or the concept that the addition of one gene may have an effect on the behavior of other genes. When a genetic system has significant epistasis, it becomes difficult or impossible to relate the good or bad performance of a candidate solution to the effects of specific genes.

The need for suitable representation of candidate solutions, or a suitable mapping to a well-understood representation, is a serious problem for the general applicability of genetic algorithms and other weak methods of optimization. Existing optimization methods require an expert to define—for each new problem to be solved—a suitable representation or mapping. The expert must ensure that the fitness landscape is not too rugged, has strong causality, and has sufficiently low epistasis. This requires both deep expertise and substantial labor. As a result, a tool or technique for developing effective representations for candidate solutions would make existing weak methods for optimization much more valuable.

Researchers have long understood the potential advantages of hierarchical representations for candidate solutions. Herbert Simon established the key principles in 1962 [Simon 1962], when he observed that hierarchical structures are more readily evolved in nature: “. . . the lesson for biological evolution is quite clear and direct. The time required for the evolution of a complex form from simple elements depends critically on the numbers and distribution of potential intermediate stable forms. In particular, if there exists a hierarchy of potential stable ‘subassemblies,’ with about the same span, s, at each level of the hierarchy, then the time required for subassembly can be expected to be about the same at each level—that is, proportional to 1/(1−p)\hat{ }s.”

John Holland understood the implications of Simon's observation for efficient optimization. In 1975 [Holland 1975], he proposed using punctuation symbols in a character sequence to mark the different levels of hierarchy. This representation permits genetic operators to take advantage of the hierarchical structure of the representation when deriving new candidate solutions. In addition, as John Holland explained, “The resulting structure offers the possibility of quickly pinpointing responsibility for good or bad performance. (E.g., a hierarchy of 5 levels in which each unit is composed of 10 lower level units allows any one of 10e5 components to be selected by a sequence of 5 tests.) In the hierarchy, the units at each level are subject to the same ‘stability’ considerations as schemata . . .” Holland then tied this idea directly to Simon's earlier work. He stated, “Chapter 4 of Simon's book, The Sciences of the Artificial (1969), gives a good qualitative discussion of this and related topics.”

Once John Holland formalized a genetic algorithm and pointed out the desirability of evolving a variable-length hierarchical structure, it was natural for programmers to suggest evolving the most familiar hierarchical representation of a program: the program's parse tree. This was first explored by Nichael Cramer in 1985 [Cramer 1985]. Cramer defined a simple tree-structured language called TB that had a syntactic resemblance to LISP. Cramer's example of a small program in this language is as follows:

;;Set variable V0 to have the value of V1

(:ZERO V0)

(:LOOP V1 (:INC V0))

;;Multiply V3 by V4 and store the result in V5

(:ZERO V5)

(:LOOP V3 (:LOOP V4 (:INC V5)))

Cramer was the first to extend Holland's crossover operation to direct application on the parse tree for a functional programming language (a language in which programs are formed by hierarchically nested function calls). In Cramer's own words: “Specifically, Crossover on TB is defined to be the exchange of subtrees between two parent programs; this is well-defined and clearly embodies the intuitive notion of Crossover as the exchange of (possibly useful) substructures.”

John Koza further explored and popularized the use of genetic algorithms on parse trees of functional programs, which he named “genetic programming.” In U.S. Pat. No. 4,935,877, he patented a specific variation of this approach. Koza's patents and his research have focused first on the use of LISP S-expressions (symbolic expressions, which are the LISP equivalent of a parse tree) as the representation for candidate solutions, and then later on the evolution of electronic circuits and other structural designs. Koza used the top-level logic from the genetic algorithm described by Holland in 1975. For his genetic operations, Koza used specific variations of the subtree crossover operation first described in Cramer. John Koza has since written many publications and received additional patents showing how his team of researchers has evolved LISP S-expressions and structural designs to solve a wide range of real-world problems.

The parse tree of a functional program is a more expressive and flexible representation for certain problems than a linear sequence of attributes or even the hierarchical notation suggested by Holland. Most computer programmers are already skilled at reading and writing programs in functional notation, and are familiar with functional decomposition as a problem-solving technique. As a result, most programmers know how to create a set of appropriate functions for a given problem, so that parse trees have proven very useful in advancing the study of various optimization techniques.

However, many researchers have pointed out substantial problems both in theory and in practice with evolving the parse trees of conventional computer programming languages. The theoretical problems, and apparently the practical problems, are due to the fact that even a tiny syntactic change in a conventional program often has an enormous impact on its behavior. For example, Chris Thornton explains [Thornton 1997]: “the observation that the schema theorem effectively assumes low epistasis, may help to explain the problems that some researchers have encountered in the use of C-GAs [crossover-based genetic algorithms] in genetic programming. In this application, high-fitness genotypes are programs for a given task and the genotype is thus literally an encoding of a mechanism. Fitness is not independently attributable to individual parts of the genotype, but only to their interactions.”

Anyone with significant computer programming experience can intuitively understand this problem. Consider, for example, a personal accounting program that correctly calculates Pennsylvania state income taxes. Then consider a second computer program, written in the same programming language by a different author for a similar purpose. Suppose, for example, that this second computer program is a general ledger package. Now consider a crossover operation that randomly replaces one or several subtrees from the general ledger program's parse tree with subtrees from the personal accounting package's parse tree. It is astronomically unlikely that the result will be a general ledger package that correctly and usefully calculates the Pennsylvania state income tax. It is far more likely that the result will be a piece of software that crashes without doing anything useful. This illustrates Thornton's point above: if lines of code for programs in conventional languages are treated as genes, then they have very high epistasis. Individual lines of code in a conventional computer program have no independent meaning, apart from their mutual interaction.

Similarly, imagine taking the personal accounting program and randomly making a small syntactic change to it. For example, imagine taking one line of code and randomly modifying it. An experienced computer programmer knows that the modified program is likely to be far less “fit” than the original. It will likely crash on certain operations. At best, it will likely make serious calculation errors. This illustrates that programs in conventional programming languages do not obey the principle of strong causality.

Writing in 1998 about John Koza's work, Droste and Wiesmann [Droste, Wiesmann 1998] observe “Even if the two parental S-expressions have a rather similar functional behaviour, the functional behaviour of the child can vary drastically from that of the parents and there is no general method known for predicting it.”

While variable-length hierarchies and program parse trees have provided advantages in organizing and analyzing candidate solutions to problems, they suffer from the fact that candidate solutions in such representations tend to have weak causality and high epistasis. As a result, their usefulness depends greatly on the problem being solved, and the ability for non-technical people to develop and make use of such representations is limited.

What is needed is a representation technique that can reliably produce candidate solutions with desirable features, and can be used by non-technical individuals to represent, develop, and optimize candidate solutions to a problem.

In one preferred form, the invention relates to a method and system for constructing a computer program that solves a problem. The invention includes defining a set of traits in which each trait characterizes a portion of a solution algorithm to the problem and defining a programming interface for at least one of the traits. The invention further includes providing an implementation for at least one of the defined programming interfaces. A subtrait associated with at least one of the traits or the implementations is specified and a top-level trait is selected that characterizes a solution to the problem. In addition, a top-level implementation for the top-level trait is selected along with an implementation for each subtrait required for the top-level trait or the top-level implementation. Lastly, an implementation for each subtrait associated with at least one of the traits or the implementations is recursively selected in order to construct a trait hierarchy that forms a computer program for solving the problem.

In alternative forms of the invention, the trait may comprises a plurality of traits, a computer programming interface may be defined for each of the traits, an implementation may be provided for each computer programming interface, the subtrait may comprises a plurality of subtraits, the top-level trait may comprise a plurality of top-level traits, the implementation may comprise a plurality of implementations. Alternately, the subtraits may be associated with at least one of the traits, the implementation, or both. And, the subtrait may be one of the defined set of traits.

In a other alternate form the invention includes implementing an evaluation module that executes a constructed computer program in order to determine its effectiveness in solving the problem; and applying an optimization technique that carries out the computer program constructing steps to generate at least one computer program that solves the problem, and that uses feedback from the evaluation module to generate at least one additional computer program that better solves the problem. In addition, the optimization technique can be selected from the group consisting of simulated annealing, an evolutionary algorithm, and a particle swarm optimization. Also, the user may be allowed to interactively choose which trait implementations will be favored or excluded at each point in each alternative computer program created by the optimization technique.

In another form of the invention, at least one self-describing method forms part of the trait implementation's interface that provides information about the trait implementation or its associated subtrait; and the at least one self-describing method is implemented as part of the trait implementation. The self-describing method may be used in a user interface to provide descriptions and other detailed information about the constructed solution algorithm. The self-describing method may also be used in an optimization technique to assist in the creation of alternative computer programs. The self-describing method may also be used in an interactive development environment to assist a user in assembling computer programs.

### SUMMARY OF THE INVENTION

The present invention defines a method of representing computer programs wherein the components of the possible programs are encapsulated as a well-defined set of self-describing traits and self-describing trait implementations. Typically, a program implemented in this manner is a hierarchy of traits and trait implementations that provide all required components of the program.

The present invention allows the individual components of a program to be replaced at run time in a way that preserves the integrity and viability of the program. Each trait in a program defines an interface that is required by that trait. There can be multiple implementations of each trait, so long as each trait implementation adheres to the interface. This allows alternative implementations of each trait to be selected by a human user or an optimization algorithm. Trait implementations are defined such that they exist independently of the program, permitting each trait implementation to be understood and appreciated independently. Each trait or trait implementation is also defined to require a specific set of subtraits, which are simply traits at the next level down in the hierarchy.

This approach allows a human user to create functioning computer programs more quickly and with less skill than is otherwise required, for several reasons: a hierarchy (such as an outline) is easy to understand; each trait contains its own documentation; and the user is constrained to place trait implementations only in traits where they will function. Similarly, this approach allows an optimization algorithm to automatically and efficiently create useful new computer programs because, instead of searching an arbitrary space of (mostly non-functioning) computer programs, it need only search the much smaller and purposefully designed space of traits that specify required interfaces and trait implementations that support those interfaces.

According to one aspect of the present invention, the top-level interface that a computer program will support is defined by a top-level trait. One or more trait implementations are provided that implement this top-level interface and that define additional subtraits required to fully implement the program. Each subtrait, in turn, defines its own programming interface required for the subtrait implementation. It will be appreciated that for a given trait or subtrait, multiple implementations can be created that all implement the same interface but that define different sets of subordinate traits.

It should be noted that a solution could alternately be characterized as a set of multiple top-level traits, with each top-level trait providing an interface, and each implementation of this interface providing a list of required subtraits. Because this is a straightforward variation on the case where a single top-level trait is used, the present document will focus on the latter approach.

According to another aspect of the present invention, a programmer defines one or more implementations for each trait and subtrait. Each implementation supports an interface defined by the specific trait, and each implementation specifies the subtraits that it requires. This process continues: additional implementations support the interfaces defined by any subtraits, and these additional implementations may define their own subtraits. A solution to the problem is constructed by selecting a specific trait implementation for the top-level trait, and recursively selecting specific implementations for any subtraits required by selected implementations. This process produces a hierarchy of traits, each of which characterizes some portion of a solution to the problem. The corresponding hierarchy of trait implementations forms the complete computer program.

The composition of a program is immediately apparent from its trait hierarchy. Alternative programs can be created by selecting alternate implementations of specific traits in the hierarchy. It should be understood that an alternate trait implementation may require a different set of subtraits than the original implementation, which may necessitate the recursive selection of additional implementations for these and any subsequent subtraits.

Having each trait implementation specify its subtraits provides flexibility for programmers and users. Each trait implementation is able to specify the subordinate capabilities that it requires. An alternative approach would be to specify required subtraits in the interface defined for each trait (or equivalently, directly in each trait definition). This alternative approach is simpler, since the hierarchy of traits is fixed instead of being dependent on the selected implementations. However, this alternative approach is less flexible. It is equivalent to following the original approach but specifying the same set of subtraits in every alternative implementation of a given trait. Therefore, the present discussion will focus on the approach where each trait implementation is permitted to specify different subtraits.

When the traits and trait implementations are designed using standard best practices for modular decomposition, the resulting space of possible programs—used as candidate solutions in an optimization technique—inherently has strong causality and low epistasis. A candidate solution is altered by replacing one or more trait implementations with other implementations of the same interface. The resulting solution is likely to be similar in behavior (and thus performance) to the original solution, which is the definition of strong causality. Similarly, because the changes are constrained to occur along modular boundaries, replacement of one trait implementation with another should not greatly affect the behavior (or impact on performance) of other traits, which is the definition of low epistasis.

As an enhancement to the present invention, a simulation module is created that evaluates the performance of a given program as a candidate solution to a target problem. A set of candidate solutions can be generated either manually or automatically by choosing one implementation for each trait. Based on the performance of each candidate solution, alternate candidate solutions can be generated and evaluated using optimization and search techniques that are well known in the art. These techniques include simulated annealing, evolutionary algorithms, and particle swarm optimizations.

As another enhancement to the present invention, common interfaces can be defined that to provide descriptive information about each trait and trait implementation. Modern programming languages, such as C++ and Java, permit the creation of an abstract class or interface for this purpose. Each trait and trait implementation can then inherit from the abstract class or support the interface. The descriptive information provided by such a common interface can include, but is not limited to, the interface required by the trait or supported by the trait implementation; the name, brief summary, description, and other documentation-related information for the trait or trait implementation; a list of the subtraits for each trait implementation; the interface required for each subtrait; numerical or descriptive measures of the expected relevance, importance, or usefulness of each trait implementation; and statistical information such as the number of constructed or active solutions containing the trait implementation, or the average fitness measurement of solutions containing the trait implementation.

Traits that support such a common interface are called self-describing traits, and the methods or routines that are required by the common interface are called self-describing methods. Similarly, trait implementations that support such a common interface are called self-describing trait implementations. Self-describing traits and trait implementations are useful in graphical user interfaces that facilitate construction of computer programs or present the modules in existing computer programs, since the self-describing methods can be used to obtain descriptions, feedback, and other information about the components required or utilized by specific selections. Self-describing traits are also useful for computer tools such as optimization algorithms and computerized solution builders, because the self-describing methods facilitate the interpretation and selection of traits within existing or newly constructed solutions.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a flow chart diagram of a preferred method for building a single candidate solution, such as a computer program that may solve a target problem, as disclosed by the present invention;

FIG. 2 is a schematic representation of a representative single candidate solution built by the present invention method including alternative trait implementations;

FIG. 3 is a flow chart diagram of one preferred method in accordance with the present invention for applying an automatic optimization technique to generate at least one computer program that better solves the target problem;

FIG. 4 is a schematic representation that shows one set of preferred software and hardware components utilized for carrying out the invention described in FIGS. 1-3;

FIG. 5 is a schematic representation of an exemplary preferred interactive development environment in accordance with the present invention for assisting a human user in assembling a computer program;

FIG. 6 is a schematic representation of an exemplary preferred single candidate solution in accordance with the present invention for the specific problem of how to buy and sell stocks, including alternative trait implementations;

FIG. 7 is a schematic representation of exemplary information contained in an object associated with a self-describing trait, using examples from the candidate solution of FIG. 6;

FIG. 8 is a schematic representation of exemplary information contained in an object associated with a self-describing trait implementation, using an example from the candidate solution of FIG. 6; and

FIG. 9 is a schematic representation of the exemplary preferred additional information associated with each trait and trait implementation to provide documentation for use in an interactive development environrnent, in accordance with the present invention.

### DETAILED DESCRIPTION OF THE PREFERRED EMBODIMENTS

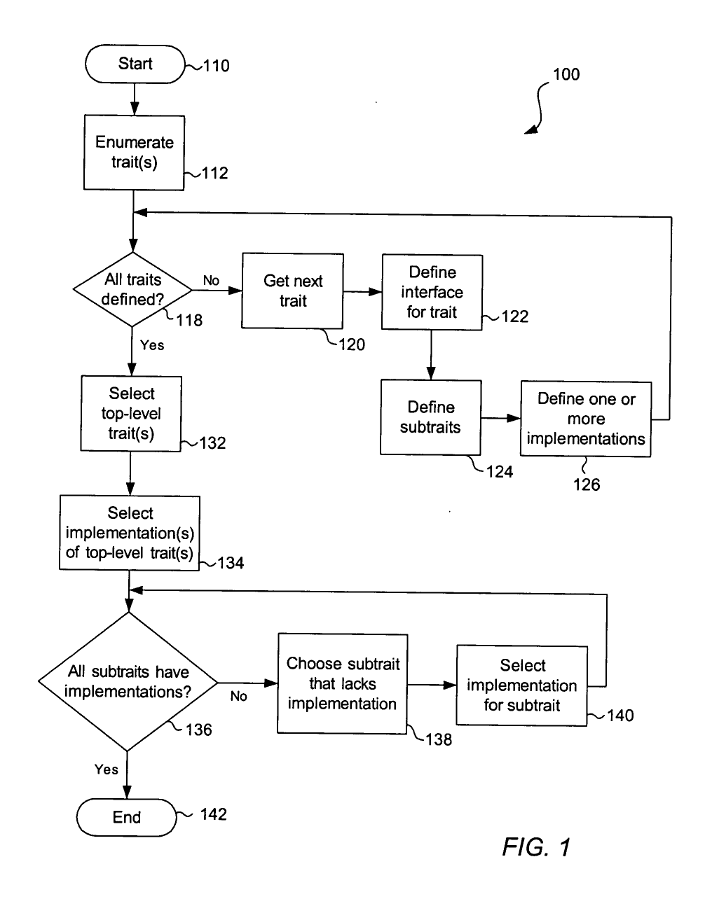

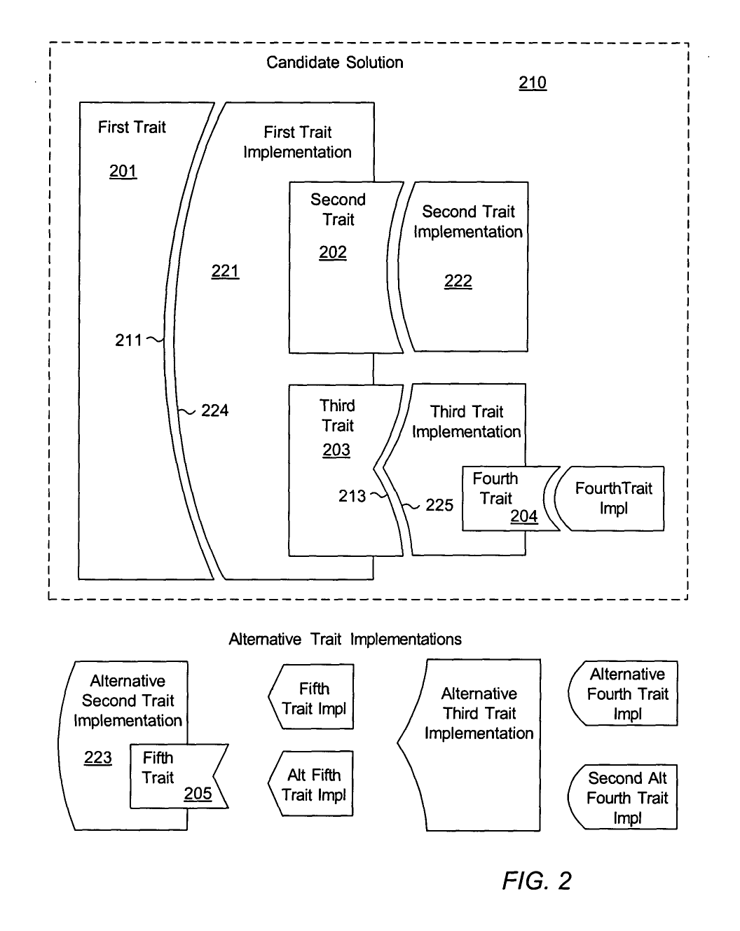

In FIGS. 1 and 2, there is shown a preferred method 100 for building a single candidate solution 210 for a target problem in accordance with the present invention.

FIG. 1 illustrates in flow chart diagram forming the candidate solution building method 100. After initiating at start block 110, the method 100 begins by enumerating at least one trait for a given problem in step 112. For example, FIG. 2 illustrates five exemplary traits, labeled 201, 202, 203, 204, and 205, that may be enumerated in step 112. Each trait characterizes a portion of the candidate solution 210 to the target problem. In addition, each trait defines a programming interface that is supported by every corresponding trait implementation. For example, in FIG. 2, the trait programming interfaces are symbolized by curved surfaces on the right-hand side of the traits 201-205, such as the surfaces 211 and 213. It is well understood that object oriented languages, such as Java, typically have built-in mechanisms for defining such programming interfaces.

Referring back again to FIG. 1, in step 118 the method checks to determine whether a set of information is defined for each enumeated trait. If not, the method proceeds to recursively define each undefined trait. Beginning with step 120, the set of information for the next undefined trait is defined. This set of information includes a programming interface for the trait, which is defined in step 122; any particular subtraits which may be available for the trait, which may be defined in step 124; and at least one implementation of the trait's programming interface, which is defined in step 126. The subtraits defined in step 124 may be associated with the trait selected in block 120 or the subtraits may be specific to each separate implementation for the trait defined in step 126. Associating a set of subtraits with each implementation is preferred, and allows different implementations for a trait to require a different set of subtraits. A subtrait defined in step 124 may come from the set of traits originally enumerated in step 112, or it may be a newly identified trait. Each newly identified trait is added to the set of traits from step 112.

The programming interface for a trait may be simple or complex. In its simplest form the programming interface may be a character string, an integer, or a floating-point number. In this case, the trait implementation may be a primitive value such as the character string “turtle soup,” the integer 5, or the floating-point number 5.72. Even if the programming interface for a trait is a more complex user-defined type, such as an interface representing an employee in an office environment, the trait implementation may still be a specific enumerated value such as an object that represents the employee John Jones.

Referring now to FIG. 2, numerous trait implementations, such as trait implementations 221, 222, and 223, are depicted. Each implementation supports the programming interface for the corresponding trait. This is symbolized in FIG. 2 by a curved surface on the left-hand side of the trait implementation, such as the surfaces 224 and 225. In FIG. 2, each trait implementation defines a set of subtraits. For example, trait implementation 221 defines subtraits 202 and 203. It should be understood, however, that each subtrait may alternately be defined by the trait itself, instead of being specific to the implementation.

Referring back again to FIG. 1, once the programming interface, subtraits, and implementations have been defined for all traits in steps 118-126, a specific solution to the given target problem is now generated in step 132 by first selecting one or more top-level traits that characterize the candidate solution 210 to the target problem. An example of a top-level trait is depicted in FIG. 2 as trait 201. One or more top-level traits are chosen to provide a high-level characterization of the candidate solution. In the preferred method 100 for building a single candidate solution, each top-level trait is selected from the set of traits enumerated in step 112. Alternatively, it would be possible to choose a top-level trait that has not yet been enumerated in step 112 or defined in steps 118-126. In that case, the top-level trait would be added to the set of traits enumerated in step 112 and the necessary information would be defined for the top-level trait by repeated steps 118-126 for that trait.

Once the top-level trait or traits have been selected in step 132, specific implementations of the top-level trait(s) are next selected in step 134. Each selected trait implementation, or each top-level trait, may define additional subtraits that are required to solve the target problem and complete the program. These subtraits further refine the characterization of the candidate solution. For example, in FIG. 2, the top-level trait implementation 221 defines the subtraits 202 and 203. As a result, the implementations 222 and 223 for subtraits 203 and 203, respectively, are required to solve the candidate solution 210.

In an object-oriented language, such as Java, a trait implementation, such as implementation 222, corresponds to a class or primitive value that supports the trait interface. The use of traits and subtraits formalizes the relationship between programming modules in an object oriented manner, and ensures the ability to manually or programmatically replace or modify specific modules of the resulting program to generate alternate solutions.

After the implementation(s) of top-level trait(s) have been selected in step 134, the method queries whether the required implementations have been chosen for each subtrait in step 136. First, in step 138 a subtrait is chosen that lacks a selected implementation. Next, in step 140 an implementation is selected for the subtrait. Since the newly chosen subtrait implementation may define further subtraits that require implementation, steps 136, 138, and 140 are repeated in a recursive fashion until no additional subtraits lack implementations. When this has been completed, a candidate solution to the problem is fully specified and the end of the process is signified in step 142.

Referring now to FIG. 2, the candidate solution 210 is shown as a completed hierarchy because implementations have been selected for all traits and subtraits that appear in the candidate solution. For example, first trait implementation 222 has been chosen as an implementation of first trait 202, instead of the alternative first trait implementation 223. It should be noted that the candidate solution 210 does not require any implementation of fifth trait 205, for example, because fifth trait 205 is defined by alternative second trait implementation 223, which is not part of the candidate solution 210.

The set of possible traits and the set of possible implementations for each trait may be modified at any time during or after the construction of one or more candidate solutions. Such modifications include the addition of new traits, the creation of new implementations for existing traits, and the modification or replacement of existing trait implementations. These modifications can then be used to construct alternative solutions to the given target problem.

Optimizing a Solution

Finding an optimal solution typically requires choosing the best implementations or values for each of the traits and subtraits. There are a number of well-known optimization techniques that could be used for this purpose, including random sampling, hill climbing, an evolutionary algorithm such as a genetic algorithm [Holland 1975] [De Jong, Spears 1989], simulated annealing [Kirpatrick et. al. 1983], and the particle swarm optimization [Hu, Eberhart 2002. These optimization techniques are well known to those skilled in the art of computer science, and are well documented in the literature.

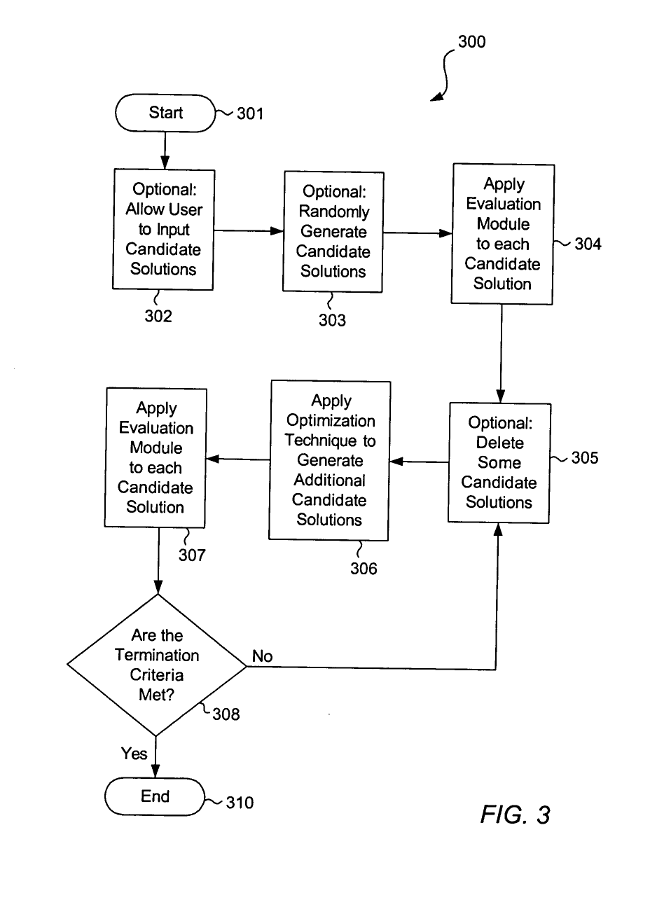

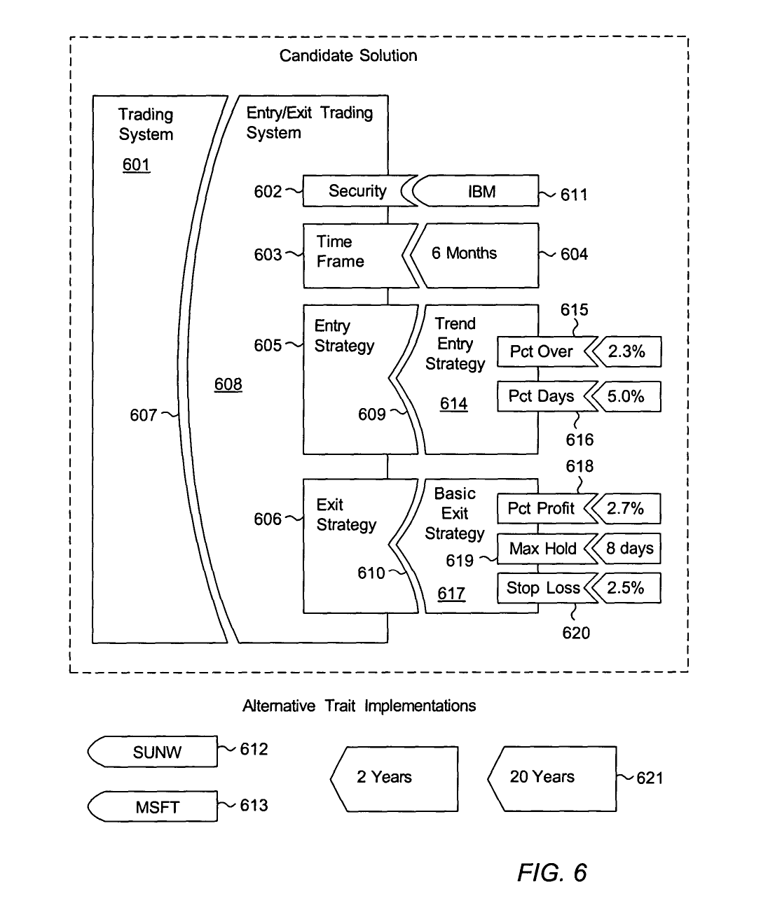

FIG. 3 depicts the general process 300 involved in applying any automatic optimization technique to generate at least one computer program that better solves the target problem. Beginning with start step 301, as an optional step, the user may be permitted in step 302 to input one or more candidate solutions. This could be done, for example, in an interactive development environment such as illustrated in FIG. 6 and described in greater detail below.

Next, as another optional step, one or more additional candidate solutions may be generated at random in step 303. This may be accomplished by automatically applying the process 100 and randomly selecting a trait implementation for each trait.

Either or both of the process steps 302 and 303 may be applied, so long as at least one candidate solution is generated. In step 304, an evaluation module is applied to each candidate solution generated in steps 302 and 303 to execute each candidate solution and determine its effectiveness in solving the target problem.

Optionally, in step 305 one or more candidate solutions may be eliminated. The choice of which candidate solutions to eliminate depends on the specific optimization technique chosen. Also, depending on the specific technique, all but a single candidate solution may be eliminated, a larger fixed number of candidate solutions may be retained, or a variable number of candidate solutions may be retained.

Next, in step 306 one or more additional candidate solutions are generated by applying an optimization technique. The manner in which this is done varies widely, depending on the specific optimization technique chosen. For example, if random sampling is used, an additional candidate solution will be generated at random. If hill climbing is used, a single existing candidate solution will be incrementally modified to find the direction of modification in which effectiveness improves.

In step 307, the evaluation module is again applied to each of the candidate solutions that have been generated. Then, in step 308, termination criteria are considered to decide whether the optimal solution has been found and the program can terminate in step 310 or whether the process returns to candidate elimination step 305. The choice of termination criteria varies widely depending on the specific optimization technique chosen. For example, termination may be based on the number of candidate solutions evaluated, the time elapsed, or the effectiveness that has been achieved, to name but a few criteria.

Example of an Optimization Technique: Simulated Annealing

For clarity, automatic optimization will now be described in more detail using a specific optimization technique: simulated annealing. This will help illustrate the general principles involved in using the present invention with a particular optimization technique. It is a specific preferred example of how the process 300 could be carried out. It should be understood that many alternate examples are suitable for practicing the present invention.

Simulated annealing works by analogy to the physical process of slowly cooling glasses or metals. In the physical process, a highly stable (low energy) state is found by random physical change as the temperature slowly declines. In the analogous software process, an optimal solution is found by randomly changing a candidate solution as a numeric temperature slowly declines.

Each time the candidate solution is randomly changed, the quality of the solution is evaluated according to some appropriate function. If the new candidate solution is better, it replaces the old one. If the new candidate solution is worse, it may still replace the old one, depending on how much worse it is and how high the current temperature is.

More specifically, if the new candidate solution is worse, it has the following probability p of replacing the old one:

p=exp (δf/T)

where δf is the change in the quality of the solution, T is the current temperature, and exp( ) represents the mathematical number e raised to the given power. For δf equal to −T, for example, the probability of the new solution replacing the old one would be 1/e, or a bit more than a 1 in 3 chance.

The simulated annealing process begins with a solution that a human operator believes to be “good” (or possibly just with a random initial solution) and an initial temperature. The algorithm then proceeds as follows with reference made to the corresponding steps of method 300:

```
Start with a candidate solution. (steps 301, 302 and 303)
                    Start with an initial temperature T.
Calculate the quality of the candidate solution. (step 304)
Repeat until (temperature T <= 0). (steps 308 and 310)
    Make a small random change to the solution. (step 306)
    Calculate the quality of this new solution. (step 307)
    // Now make a determination of whether to keep the old solution
    // or replace it with the new one. (step 305)
    if (quality of new solution > quality of current solution)
            then keep the new solution, deleting the old;
        else
            if (random(0.0, 1.0) < the probability exp (δf / T))
                then keep the new solution, deleting the old;
            else
                delete the new solution and keep the old.
    Decrement the current temperature T one “notch”.
```

Simulated annealing can be visualized as a ping-pong ball bouncing over a surface pocketed with hills and valleys. The ball will bounce up hills to a certain extent, but will eventually slow down and settle in a valley somewhere. In the same way, simulated annealing permits the solution to vary between “better” and “worse” to a certain extent before settling to what is relatively a “best” solution.

The present invention provides a straightforward way to randomly change one candidate solution into a sensible “similar” solution. This is important for the performance of optimization algorithms, such as simulated annealing. For example, the following algorithm could be used to randomly modify a candidate solution. (This is one way to carry out step 306.)

```
Start with a candidate solution.
Determine the set of all traits in the candidate solution.
Randomly select a trait to modify. (Since changing a deeper subtrait
usually has a
smaller incremental effect on the solution, it is
    Usually best to weight subtraits so that they are more likely
    to be selected than
    their “parent” traits.)
If this is a simple trait,
    then randomly change its value;
else
    find out the available implementations;
    randomly choose a different implementation than the current one;
    and if that implementation has subtraits, then randomly choose
        values for them.
```

It should be understood that the above algorithm may be used with any solution built according to the present invention, and is not specific to any particular example.

Hardware and Software Components

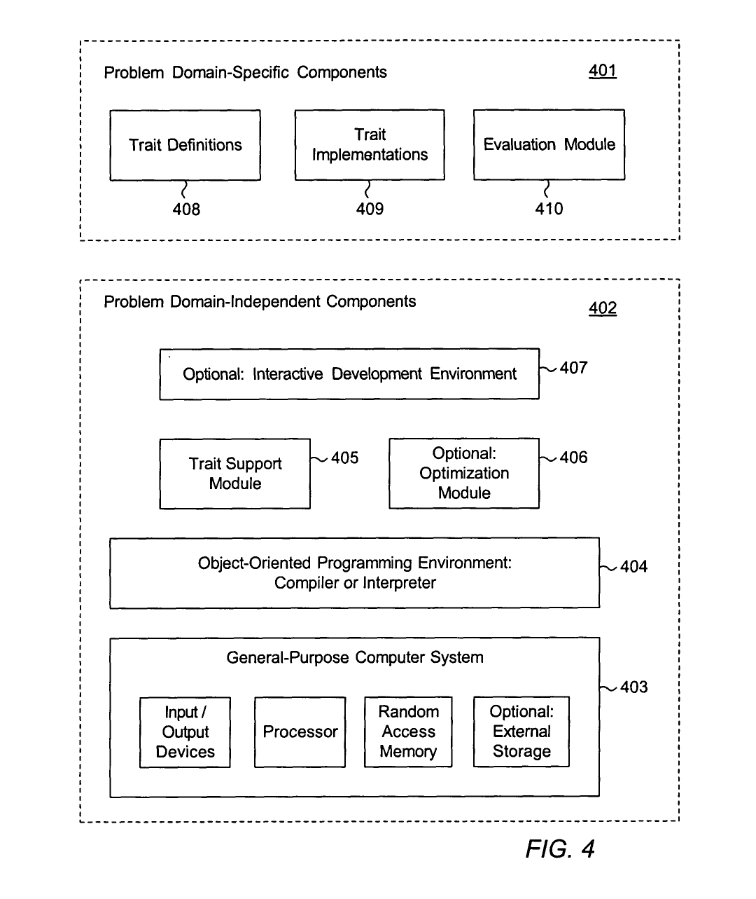

FIG. 4 is a schematic representation of the major software and hardware components required to carry out the steps shown in FIGS. 1-3. The preferred software components that are specific to the type of problem being solved are included in block 401. These components are reusable for different problems in the same domain (such as the example of buying and selling securities discussed below), but new components must be written to solve problems in a different domain. The software and hardware components that are independent of the type of problem being solved (and thus reusable across all problem domains) are included in block 402 and described below. It is a substantial advantage of the present invention that most of the necessary infrastructure is problem domain-independent. The preferred embodiment of this invention uses all of the components in FIG. 4, including the ones labeled “optional.” However, it should be understood that using less than all the components may be preferable depending upon the circumstances.

The problem domain independent components 402 include a general-purpose computer system 403. The present invention does not place any special requirements on this device. Components 402 also include an object-oriented programming environment 404, such as C++ or Java. The preferred embodiment uses Java, for two reasons. First, Java programming environments enforce strong boundaries between different modules, such as different trait implementations. This helps reduce the time spent diagnosing programming errors when trait implementations are recombined in different permutations to form large numbers of candidate solutions. Second, Java supports a technique called “reflection,” in which a Java program automatically examines its own modules. This is convenient for allowing the Trait Support Module (described below) to automatically obtain information about the traits and trait implementations.

The Trait Support Module 405 is a library of supporting code that maintains a dynamic registry of traits and trait implementations that simplifies the development of new trait implementations. This module 405 maintains the information defined for each trait defined in steps 118 and 120 of the candidate solution building method 100. For example, module 405 records the programming interface defined for the trait in step 122, the zero or more subtraits for the trait defined in step 124, and the implementations of the trait's programming interface defined in step 126.

Referring back to FIG. 4, an optional Optimization Module 406 is included that carries out the optimization technique discussed above. Optimization Module 406 is not necessary if all candidate solutions will be created by a human user.

An Interactive Development Environment 407 allows a user to interactively assemble candidate solutions. It may also allow the user to indicate which trait implementations will be favored or excluded at each point in each alternative computer program created by the Optimization Module 406. The Interactive Development Environment 407 is not necessary if the Optimization Module 406 will create all candidate solutions, and if the user does not need to indicate which trait implementations will be favored or excluded.

The remaining components are included in problem domain-specific components 401. A set of Trait Definitions 408 indicates which traits are possible in a candidate solution. This is the same set of traits that is enumerated in step 112 of candidate solution building method 100. It is also the same set of traits 201, 202, 203, 204, and 205 that are included in the candidate solution 210 of FIG. 2.

Referring again to FIG. 4, the set of available Trait Implementations 409 is also included in the problem domain-specific components 401. This is the same set of trait implementations that are defined in step 126 of method 100 of FIG. 1. It is also the same set of trait implementations 221, 222, and 223 that are illustrated in the candidate solution 210 of FIG. 2

Finally, an Evaluation Module 410 is also included that executes a constructed computer program in order to determine its effectiveness in solving the problem. The manner in which this is done depends on the target problem domain. In general, it involves invoking one or more methods of the one or more top-level trait implementations and examining the results. In the example of buying and selling securities set forth below, the Evaluation Module 410 is the code that invokes the “simulate” method and examines the resulting profit.

Components of the Interactive Development Environment

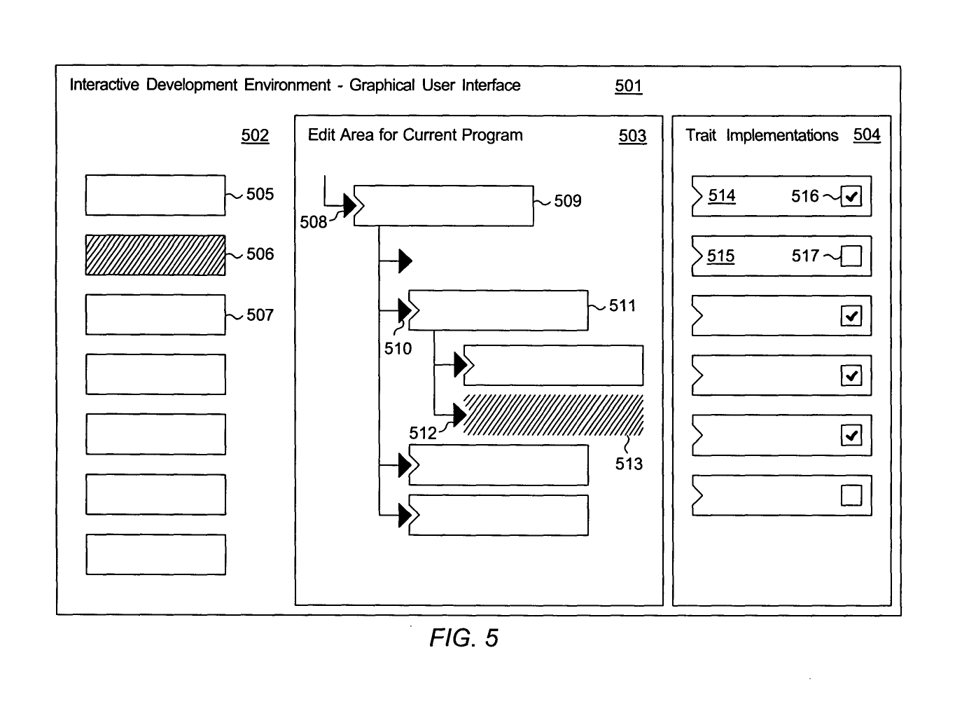

FIG. 5 is one preferred schematic representation of an interactive development environment 501 that assists a human user in assembling computer programs as disclosed by the present invention. The schematic of FIG. 5 shows the most important visual components of the interactive development environment as they might appear in an area of a graphical user interface. One skilled in the art of graphical user interface design could find many different ways to draw these components and lay them out in one or more areas or windows. Also, the same principles could be used to create a different style of user interface, such as a purely textual user interface.

The interactive development environment 501 includes one or more areas or windows including a candidate programs area 502, the edit area for current programs are 503, and the trait implementations area 504. The candidate programs area 502 represents a window or screen area that depicts a list of candidate solutions. The edit area for current programs 503 represents a window or screen area that allows the user to create or modify a single candidate solution. And, the trait implementations area 504 represents a window or screen area that allows the user to select a trait implementation for use in a candidate solution.

Looking at candidate programs area 502 in more detail, there are seven candidate solutions depicted as blocks 505, 506, 507, and so on. The depiction of the candidate solution in the graphical user interface includes descriptive information, such as a name that the user has assigned to the solution, or an indication of the performance of the solution as determined by the Evaluation Module 410.

The crosshatched candidate solution block 506 indicates that the corresponding candidate solution has been selected by the user for modification. For example, the user may have clicked on block 506 with a selection device such as a mouse. The edit area for current programs 503 depicts the hierarchy of traits and trait implementations for this candidate solution. Triangle 508 represents the one or more top-level traits of the candidate solution. Block 509 represents the implementation of this top-level trait. The depiction of traits and trait implementations in the graphical user interface would include descriptive information such as names, descriptions, and names of trait programming interfaces.

Similarly, triangle 510 represents a subtrait of trait implementation 509 for which the user has already chosen a trait implementation. The chosen trait implementation is represented by block 511. Triangle 512 represents a subtrait of trait implementation 511 for which the user has not yet chosen a trait implementation. The crosshatched area 513 represents a visual indication that the user has selected trait 512 with the intention of next choosing an implementation for that trait.

Looking at trait implementations area 504 in more detail, it shows the user being presented with depictions of a plurality of alternative trait implementations, represented by blocks 514, 515 and so on. The user interface allows the user to choose one of these trait implementations for the selected trait 512 of the candidate solution 210. For example, the user interface may allow the user to drag trait implementation block 514 and drop it onto the crosshatched area 513, representing the selected trait. In this way, the trait implementation 514 is associated with trait 513.

The window or screen area represented by the trait implementations area 504 also provides the user with a mechanism for indicating which trait implementations should be favored or excluded at each point in each alternative computer program that will later be created by the optimization technique. This is represented in FIG. 5 by selection areas 516 and 517. The check mark in selection area 516 represents a graphical indication that trait implementation 514 should be favored for use with trait 512. The empty block 517 represents a graphical indication that trait implementation 515 should be excluded from use with trait 512.

Example of a Target Problem: Buying and Selling Financial Securities

As an example, it is useful to consider the well-known problem of optimizing the profit gained from buying and selling financial securities. This example is used only for clarity of description; the present invention may be applied to any domain in which a computer program solves a problem. This document begins with a relatively simple set of possible solutions, in order to clearly illustrate the principles involved. It then describes how this approach can extend to more complex solutions.

In this example, the desired candidate solution computer program can be characterized as a trading system. To keep the example simple, a trading system is defined as a system for buying and selling a single specific security over a specified timeframe. This highest level of problem definition is the top-level trait, and is represented in FIG. 6 by block 601. The subordinate components, or subtraits, of a trading system might include the following:

The Security 602—the name or symbol of a security.

The Time Frame 603—the period of time over which the security will be traded. A short-term investment might have the 6-month time frame 604, while a retirement account might have the 20-year time frame 621.

The Trading Strategies 605 and 606—one or more strategies to follow when deciding whether to buy or sell the security.

In the present example there are two trading strategies: an entry strategy 605 to determine when the security should be bought, and an exit strategy 606 to determine when the security should be sold. For simplicity, the example does not take into account the amount of money available for such transactions.

In its preferred embodiment, the present invention is based on an object-oriented representation of the solution. The present example uses the Java programming language. In Java, one reasonable approach is to represent the top-level trait's interface as an abstract class. The abstract class defines an interface that characterizes a solution to the problem. In FIG. 6, this interface is represented by curved line 607. In Java, it could look like the following:

```
abstract class TradingSystem {
    // Returns number of shares currently held
    abstract int getCurrentPosition( );
    // Trade some shares (positive = buy, negative = sell)
    // Internally, this records the profit and loss for a sale
    abstract void trade(int shares);
    // Calculate the total return for the current settings
    abstract double simulate( );
}
```

In this simplified code, the TradingSystem class is the interface for the top-level trait that characterizes a solution to the problem of optimizing the profit from buying and selling financial securities. This abstract class defines the interface that a programmer must implement in order to solve the problem, defining what a solution must accomplish, but not how to accomplish it.

A top-level trait implementation (which provides the top-level logic of the complete computer program) can then be defined as an implementation of the abstract class. In FIG. 6, an implementation of the top-level Trading System trait is represented by the Entry/Exit Trading System implementation 608. In Java, such a representation might look something like the following:

```
class EntryExitTradingSystem extends TradingSystem {
    double totalProfit;
    StringTrait security; // Trait: the symbol of the security
    IntegerTrait timeFrame; // Trait: number of days
    TradingStrategy entryStrategy; // Trait: determines when to buy
    TradingStrategy exitStrategy; // Trait: when to exit position
    // ... implementation is omitted here
}
```

The EntryExitTradingSystem class 608 is a specific implementation of a trading system. This implementation requires four subtraits 602, 603, 605, and 606. An alternate implementation might require a different set of subtraits. (A ComplexTradingSystem class is provided below to illustrate this point.)

Given appropriate definitions of the data types StringTrait, IntegerTrait, and TradingStrategy, these four traits represent the next level of detail of a candidate solution in a concrete and well-defined manner. Note that some traits, such as TradingStrategy, represent complex interfaces (“complex traits”) that will have alternative implementations, while other traits, such as StringTrait, represent primitive interfaces (“simple traits”) for which the implementation will primarily be a constant value. The TradingStrategy interface is represented in FIG. 6 by the curved lines 609 and 610. Constant values that implement the StringTrait interface are represented by the security symbols “IBM” 611, “SUNW” 612, and “MSFT” 613.

For a specific security, time frame, and entry and exit strategy, it is possible to simulate the performance of the trading system by processing the security on a day-by-day basis over the actual historical prices in a given time frame. This could be done with something like the following pseudo-code:

```
// Simulate the trading system with the assigned traits
double simulate( )
{
    let totalProfit = 0.0
    initialize entry strategy
    initialize exit strategy
    for each day in time frame
        retrieve price for security on this day
        evaluate entry strategy to buy security
        evaluate exit strategy to sell security
    return totalProfit
}
```

The following Java code provides a more complete definition for the EntryExitTradingSystem class 608. First, a new class called Trait is defined to represent a trait. Five instances of this class are declared:

```
public static class Trait {
    private Trait( ) {}
    public static final Trait TRADING_SYSTEM = new Trait( );
    public static final Trait SECURITY = new Trait( );
    public static final Trait TIME_FRAME = new Trait( );
    public static final Trait ENTRY_STRATEGY = new Trait( );
    public static final Trait EXIT_STRATEGY = new Trait( );
}
```

Next, a set of methods and instance variables are declared. The following Java code is a more complete definition of the EntryExitTradingSystem class 608:

public class EntryExitTradingSystem extends TradingSystem {

// Assign and retrieve a specific trait
public void setTrait(Trait name, Object value) { ... }
public Object getTrait(Trait name) { ... }
// Returns number of shares currently held
public int getCurrentPosition( ) { ... }
// Trade some shares (positive = buy, negative = sell)
// Internally, this records the profit and loss for a sale
public void trade(int shares) { ... }
// Calculate the total return for the current settings
public int simulate( ) { ... }
// Used during simulation to track the total profit
private double totalProfit = 0.0;
// Trait: the symbol of the security
private StringTrait security;
// Trait: a number of days that defines the general
// timeframe of the strategy.
private IntegerTrait timeFrame;
// Trait: determines when to buy the security
private TradingStrategy entryStrategy;
// Trait: defines when to exit a position
private TradingStrategy exitStrategy;

}

There is still something essential missing in this definition of the EntryExitTradingSystem class 608: there is no way for external code to determine which subtraits are required by the EntryExitTradingSystem, or what implementations are possible for these traits. These details will be covered below.

Representation of Traits

There are many known strategies for buying and selling securities. Generally speaking, in the trading system described by the present example, a trading strategy requires initialization plus a method for processing each day-by-day price change. The TradingStrategy interface might reasonably be defined as follows:

```
public abstract class TradingStrategy
{
    // Initialize the strategy with the current trading system
    void init(TradingSystem system);
    // Process a new day according to the strategy
    void newDay(double price);
}
```

As an example, consider a trend-following entry strategy that purchases a security whenever the current price is some percentage greater than the moving average over a prior time period. This entry strategy is represented by trend entry strategy 614. It requires two subtraits: subtrait 615 for specifying the amount that the price must be over the moving average in order to buy the security, and subtrait 616 for specifying the period of time for the average.

Each of these subtraits can be enumerated by augmenting the previously defined Trait class:

```
public static class Trait {
    private Trait( ) {}
    . . .
    // Traits for TrendEntryStrategy implementation
    // PERCENT_OVER = value from 0.0 to 1.0 indicating
    // percent above moving average price required
    // to buy the security.
    // PERCENT_DAYS = value from 0.0 to 5.0 indicating
    // moving target period as a percentage (0 to 500%)
    // of the system's time frame.
    public static final Trait PERCENT_OVER = new Trait( );
    public static final Trait PERCENT_DAYS = new Trait( );
}
```

This approach of declaring all traits as class variables of a single Trait class would be unacceptably cumbersome for large software systems, but it illustrates the important idea of enumerating and naming all traits. In the preferred embodiment of the present invention, a dynamic registry of traits and trait implementations is used instead. In that case, a database or data file contains a list of defined traits and trait implementations. This database or data file can be updated automatically or by a human user when new traits or trait implementations are defined. (The dynamic registry and the database or data file are both contained in the Trait Support Module 405) The present example will continue to use the single Trait class, because that simple approach is better for clearly explaining the other aspects of the invention.

Now that the necessary traits have been enumerated, the trend-following entry strategy trait 614 can be declared.

public class TrendEntryStrategy extends TradingStrategy
{

// Assign and retrieve the traits for this implementation
public void setTrait(Trait name, Object value) { ... }
public Object getTrait(Trait name) { ... }
private TradingSystem system;
// Number of days in the moving average
// (based on the PERCENT_DAYS trait)
private int movingDays;
// Queue to track prices over the moving average period
private DoubleQueue priceQ = new DoubleQueue( );
// Total price (sum) over the moving average period
private double totalPrice = 0.0;

}

The init( ) method can then be defined as follows. Note that this example still does not yet show how external code can assign appropriate traits. For now, the following code assumes that the two traits are somehow assigned before initialization occurs.

```
// Initialize entry strategy
public void init(TradingSystem system)
{
    this.system = system;
    // Determine number of days in moving average
    movingDays = (int)
      (getTrait(Trait.PERCENT_DAYS).doubleValue( )
        * system.getTrait(Trait.TIME_FRAME).intValue( ));
}
```

The newDay( ) method for the TrendEntryStrategy class implements the strategy. For this example, a purchase will only be considered if the current position is zero shares. The details of how the newDay( ) method would be implemented are not important for understanding the present invention, but the following code sample is provided for programmers who wish to better understand the example.

```
public void newDay(double price)
{
    // Do nothing if security is already held
    if (system.getCurrentPosition( ) > 0)
        return;
    // Add the new price to the queue
    priceQ.addFirst(price);
    totalPrice += price;
    if (priceQ.length( ) > movingDays)
    {
        // Drop the oldest price from the queue
        double oldestPrice = priceQ.removeLast( );
        totalPrice −= oldestPrice;
    }
    // See if we can calculate the moving average
    if (priceQ.length( ) == movingDays)
    {
        double avg = totalPrice / (double)movingDays;
        double target = avg + (avg
          * getTait(Trait.PERCENT_OVER).doubleValue( ));
        // See if we are ready to buy
        if (price > target)
        {
            // Purchase 100 shares
            system.trade(+100);
        }
    }
}
```

The newDay( ) method listed above first adjusts the moving average. Then, if the current price is greater than the target price based on the current average, it purchases 100 shares of the security.

The present example will use a basic exit strategy 617 that will seek to obtain a specific profit level before selling the security. It will sell after a specific number of days have passed, or when a specific loss has been reached. This exit strategy requires three subtraits, which represent the target percent profit 618, the maximum number of days to hold the position 619, and the percent loss that will force an exit 620. As before, these new traits required by BasicExitStrategy are defined by adding more declarations to the Trait class:

public class Trait {

private Trait( ) {}
. . .
// Traits for BasicExitStrategy implementation
// PERCENT_PROFIT = value from 0.0 to 1.0 indicating
// the amount of profit required before selling
// the security.
// MAX_HOLD_PERIOD = maximum number of days
to hold security.
// STOP_LOSS = value from 0.0 to 1.0 indicating the
// maximum loss to accept before selling the security.
public static final Trait PERCENT_PROFIT = new Trait( );
public static final Trait MAX_HOLD_PERIOD = new Trait( );
public static final Trait STOP_LOSS = new Trait( );

}

The Java code for BasicExitStrategy would then begin like this:

public class BasicExitStrategy extends TradingStrategy
{

// Assign and retrieve the traits for this implementation
public void setTrait(Trait name, Object value) { ... }
public Object getTrait(Trait name) { ... }
private TradingSystem system;
private double purchasePrice;
private int daysHeld;

}

The initialization method for this strategy presumes that no shares are held at the start of the simulation. As before, this example ducks the question of how traits are assigned by simply assuming they were defined before this method is implemented.

```
// Initialize exit strategy
public void init(TradingSystem system)
{
    this.system = system;
    purchasePrice = 0.0;
    daysHeld = 0;
}
```

For exit strategies, the newDay( ) method sells a held security if the appropriate criteria have been met. As was the case with the entry strategy, the details of how the newDay( ) method would be implemented are not important for understanding the present invention, but the following code sample is provided for programmers who wish to better understand the example.

```
public void newDay(double price)
{
    // Do nothing if security is not held
    int shares = system.getCurrentPosition( );
    if (shares == 0)
        return;
    if (purchasePrice == 0.0)
    {
        // Security is newly purchased
        purchasePrice = price;
        daysHeld = 0;
    }
    else
    {
        daysHeld ++;
        // Check exit criteria to see if we should sell
        double desiredProfit
        = getTrait(Trait.PERCENT_PROFIT).doubleValue( );
        double stopLoss
        = getTrait(Trait.STOP_LOSS).doubleValue( );
        int maxHold
        = getTrait(Trait.MAX_HOLD_PERIOD).intValue( );
        if (price > _purchasePrice
          && (price − _purchasePrice
            > price * desiredProfit))
        {
            // Sell to obtain profit
            system.trade(−shares);
        }
        else if (price < _purchasePrice
              && (purchasePrice − price
                > price * stopLoss))
        {
            // Sell to stop loss
            system.trade(−shares);
        }
        else if (daysHeld > maxHold)
        {
            // Max hold period reached
            system.trade(−shares);
        }
    }
}
```

Running a Simulation

Now that the entry and exit strategies are defined, it is possible to write the simulate( ) method for the trading system class. The price for a security is obtained from a source of historical data; this example uses a getPrice( ) method to represent retrieval from that data source. Here again, the details are not important for understanding the present invention, but the following code sample is provided for programmers who wish to better understand the example.

```
// Simulate the trading system with the assigned traits.
public double simulate( )
{
    // Initialize the entry strategy trait implementation.
    entryStrategy.init(this);
    // Initialize the exit strategy trait implementation.
    exitStrategy.init(this);
    // For each day in the simulation time period.
    for (int i = 0; i < timeFrame; i++)
    {
        // Get the security's price for this day.
        double price = getPrice(security, i);
        // Invoke the entry strategy's newDay method.
        entryStrategy.newDay(price);
        // Invoke the exit strategy's newDay method.
        exitStrategy.newDay(price);
    }
    return totalProfit;
}
```

For a chosen set of trait implementations, this method simulates the result of using those trait implementations within the trading system.

Representation of Self-Describing Traits

Finally, this section explains how external code can determine what subtraits are required by a particular trait implementation, and how it can determine which interfaces these subtraits must implement.

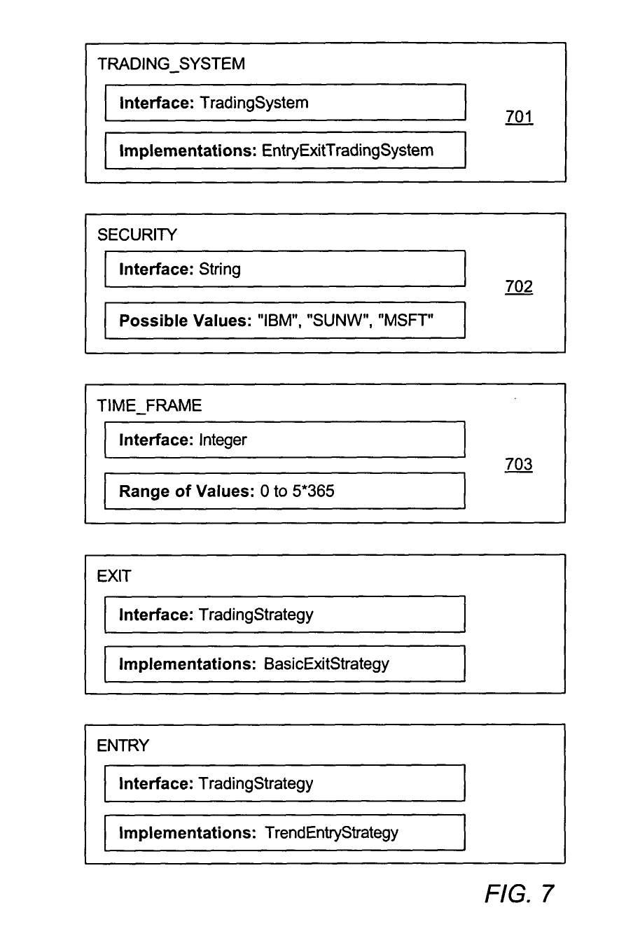

Traits can be made self-describing by extending the Trait class with methods that provide descriptive information about each trait. FIG. 7 shows the information that each Trait object contains. Each complex trait, such as the TRADING_SYSTEM trait 701, is associated with a Trait object that records the programming interface for the trait and the list of possible implementations for the trait. Each trait that is simply a character string, such as the SECURITY trait 702, is associated with a Trait object that records the possible values, such as “IBM”, “SUNW”, and “MSFT.” Each trait that is simply a number, such as the TIME_FRAME trait 703, is associated with a Trait object that records the possible range of values.

This information could be represented in Java code as follows:

public static class Trait {

private Class_interface;
private Class[] implementations;
private String[] possibleValues;
private Trait(Class interface, Class[] implementations) {

interface = interface;
implementations = implementations;
possibleValues = null;

}
private Trait(String[] possibleValues) {

interface = String.class;
implementations = new Class[] { String.class };
possibleValues = possibleValues;

}
private Trait(double minValue, double maxValue) {

interface = Double.TYPE;
implementations = new Class[] { Double.TYPE };
possibleValues = new String[] {

minValue.ToString( ), maxValue.ToString( ) };

}
private Trait(int minValue, int maxValue) {

interface = Integer.TYPE;
implementations = new Class[] { Integer.TYPE };
possibleValues = new String[] {

“” + minValue, “” + maxValue( ) };

}
public Class getInterface( ) { return interface; }
public Class getImplementations( ) { return implementations; }
public String[] getPossibleValues( ) { return possibleValues; }
public final static Trait TRADING_SYSTEM =

new Trait(TradingSystem.class,

new Class[] {

EntryExitTradingSystem.class });

public final static Trait SECURITY =

new Trait(new String[] { “IBM”, “SUNW”, “MSFT” });

// Allow a time frame of 0 to 5 years
public final static Trait TIME_FRAME = new Trait(0, 5*365);
public final static Trait ENTRY =

new Trait(TradingStrategy.class,

new Class[] { TrendEntryStrategy.class });

public final static Trait EXIT =

new Trait(TradingStrategy.class,

new Class[] { BasicExitStrategy.class });

// Similarly for the remaining traits
. . .

}

Using the self-describing methods in this new definition of Trait, the surrounding code can determine—for any particular trait—what interface that trait has and what implementations are available.

As explained above, from a large-scale design perspective, all trait definitions would not be in a single source file. In the preferred embodiment of the present invention, the Trait Support Module 405 provides methods that allow the trait interface and implementation classes themselves to declare this information, in a completely decentralized way. However, the above definition of the Trait class captures the essential idea.

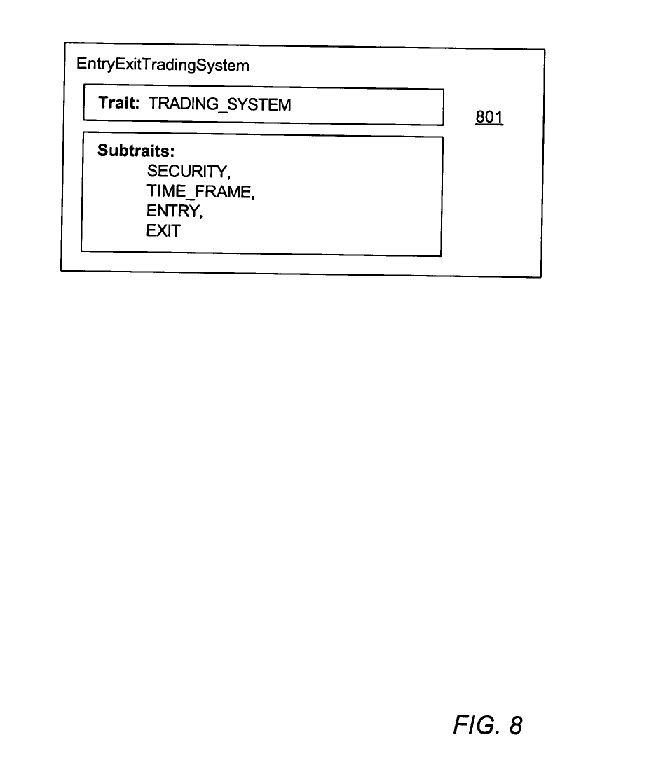

Each trait implementation must also be made self-describing by adding a TraitImplementation interface. The information that will now be associated with each trait implementation is shown in FIG. 8, where EntryExitTradingSystem trait implementation 801 is depicted as an example.

This allows external code to find out which subtraits are needed by a particular trait implementation. It also allows the previously defined getTrait(. . .) and setTrait(. . .) methods to be generalized.

```
public interface TraitImplementation {
    public Trait getTrait( );
    public Trait[] getSubTraits( );
    public Object getTrait(Trait name);
    public void setTrait(Trait name, Object value);
}
public class EntryExitTradingSystem extends TradingSystem
                        implements TraitImplementation {
    // Provide the name of the trait that we implement
    public Trait getTrait( ) {
        return Trait.TRADING_SYSTEM;
    }
    // Provide a list of our subtraits
    public Trait[] getSubTraits( ) {
        return new Trait[] {
            Trait.SECURITY,
            Trait.TIME_FRAME,
            Trait.ENTRY,
            Trait.EXIT
        };
    }
```

The definitions of the TrendEntryStrategy and BasicExitStrategy classes are modified in a similar fashion. The TraitImplementation interface provides the necessary support to permit external programs, such as an optimization technique, to interpret, construct, and modify solutions.

In a language, such as Java, that supports reflection—a technique allowing code to examine itself at runtime—it is not necessary for all of the information about a trait or trait implementation to be explicitly declared. Instead, in the preferred embodiment of the present invention, the Trait Support Module gleans some of this information automatically by examining the Java class that represents a trait or trait implementation. This may be facilitated by requiring the programmer who defines the trait or trait implementation to follow certain conventions when naming methods or variables. For example, if the programmer of a trait implementation is required to begin the name of each variable that holds a subtrait with the word “trait,” then the Trait Support Module 405 can use Java reflection to automatically find out which subtraits are needed by a trait implementation.

Additional Self-Describing Methods to Support Interactive Development Environments

The information associated with each trait and trait implementation can be extended with a name, brief description, and longer description. This information is then available for display in an interactive development environment to assist the human user in assembling useful computer programs.

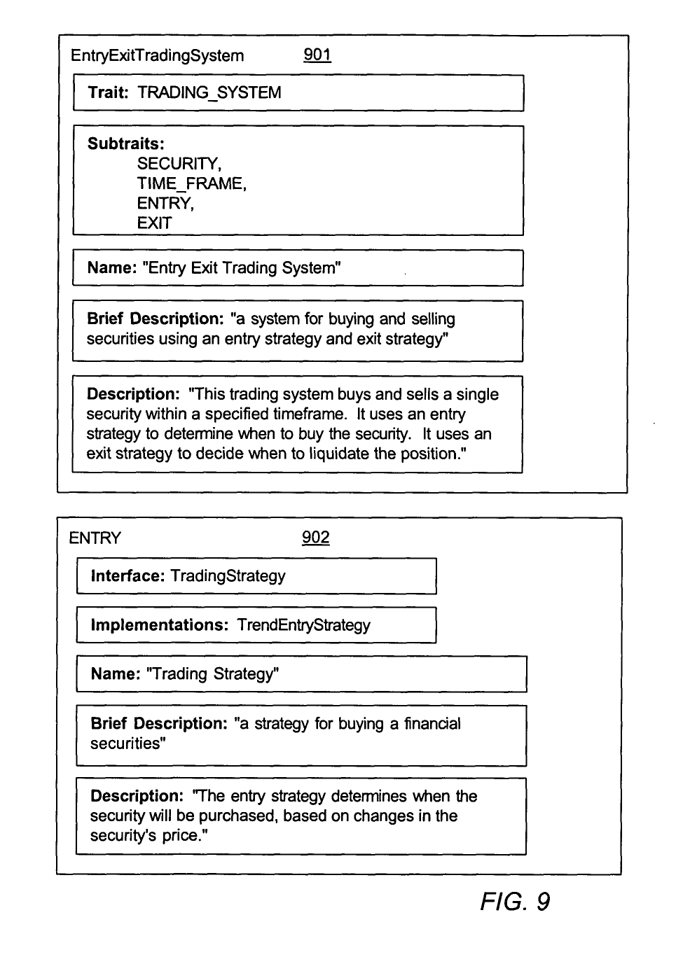

FIG. 9 illustrates how the information associated with a trait or trait implementation can be extended with this type of information. The information block 901 depicts the information that is now associated with the EntryExitTradingSystem trait implementation. Similarly, the information block 902 depicts the information that is now associated with the ENTRY trait.

The new self-describing methods on the Trait class would be defined in Java as follows:

```
public abstract class Trait {
    . . .
    public String getName( );
    public String getBriefDescription( );
    public String getDescription( );
}
```

We extend the TraitImplementation interface in a similar way, to provide self-describing methods with the additional information about trait implementations:

public interface TraitImplementation {

public Trait getTrait( );
public Trait[] getSubTraits( );
...
public String( ) getName( );
public String getBriefDescription( );
public String getDescription( );

}

In addition to descriptive methods such as those already shown, an additional extension might be to provide a measure of the expected “impact of change” for a particular implementation. In Java, this might look as follows:

public interface TraitImplementation {

...
// value from 0.0 to 1.0
public double getImpactOfChange( );

}

The “impact of change” measure could indicate a relative probability that a given implementation of a trait would change when deriving a new solution. A solution-deriving algorithm could use this as a weighting factor when selecting traits to modify in a candidate solution.

Further Extensions

The example described above is simplified to more clearly introduce the concepts and techniques involved. The present section considers how to eliminate some of these simplifications to create a more robust and realistic trading system. There is no reason to limit the trading strategy to a single entry and exit strategy. In fact, there might be numerous strategies one might wish to employ, each with its own set of implementations and required traits. A trading system could consist of a security, a time frame, and an ordered set of trading strategies. In Java, this extension could be represented as follows:

public class ComplexTradingSystem extends TradingSystem
{

...
private string security;// the symbol of the security
private int timeFrame; // number of days
private TradingStrategyQueue strategies;

}

This representation permits strategies to be added or removed from the trading system in an ordered fashion. The simulate( ) method would simply step through the strategies in the queue and invoke the newDay( ) method on each strategy. The number of strategies in the queue might vary for each solution, and incorporate the buying or selling of the security as appropriate.

Another change would be to allow a strategy to alter the set of strategies in the midst of a simulation. For example, a strategy might evaluate whether the current market conditions are more bullish or bearish, and insert or remove entry or exit strategies into the queue based on its analysis.

Another possible extension would allow multiple trait implementations to be supported using a single class. For example, a class could be supplied with different configuration data to create an effectively different implementation.

To further simplify the creation of new trait implementations, a scripting language could be developed that permits non-programmers to create implementations of traits using a well-defined set of operators.

Another approach would be to provide an interactive development environment, or IDE, that would include graphical elements for use in constructing trait implementations. Such environments are well known for the creation of graphical user interfaces, and allow users to drag graphical elements such as buttons, menus, and panels onto a window to construct a user interface. In a similar manner, an IDE using the present invention could permit implementation components such as mathematical formulas, names of securities, and timeframes (daily, weekly, etc.) to be snapped together to form new implementations of existing or desired traits.

Advantages of the Approach

The present invention for constructing candidate solutions to a problem has important advantages over the representations typically used for computer program optimization. For example, unlike a function in a functional programming language such as LISP, each trait implementation used as part of the candidate solution can have more than one entry point. In the securities trading example, the entry and exit strategies have two different entry points: init(. . .) and newDay(. . .). Also, a trait implementation can call back up to the higher-level trait implementation that contains it. This occurred in the securities trading example when the entry strategy invoked trade(+100) on the trading system to buy 100 shares of the security.

The object-oriented approach of the present invention allows alternative sub-hierarchies of traits for different candidate solutions. In the example solutions given previously for the problem of buying and selling financial securities, all candidate solutions fit into the same fixed hierarchy. Imagine, however, that numerous implementations of entry and exit strategies were provided. Each entry or exit strategy implementation could require its own unique set of subtraits.

Deeper levels of abstraction could be added to the strategy implementations. To draw an example from the securities trading scenario discussed previously, the basic exit strategy could be extended to include a profit strategy subtrait, permitting alternate choices of profittaking strategy within the same exit strategy trait implementation.

Another important advantage of the present invention is the fact that every possible combination of trait implementations represents a functioning computer program. For example, if “random” changes are made as part of an optimization technique to derive a new solution, these changes are constrained by the object-oriented representation. A given solution may be more or less fit according to the Evaluation Module, but it is guaranteed to be a valid computer program. The same principle applies when the present invention is used with an optimization technique such as a genetic algorithms—a particular type of evolutionary algorithm in which two “parent” solutions are “mated” to produce a new “child” solution. Using the present invention, such “mating” is performed at the trait level, which ensures that every child solution is a valid computer program that might reasonably solve the target problem.

Yet another advantage is that small changes to a solution are likely to result in small changes to the final result. For example, a slightly different stop loss value for the exit strategy is unlikely to change the final profit obtained to a large degree. This is also true for small changes in the time frame, or changing between similar entry strategies.

A final advantage is that each solution is clearly described in an externally accessible way. Self-describing traits and trait implementations allow the components of a successful solution to be examined and understood in detail.

The present invention may be embodied in other specific forms without departing from the spirit or essential attributes thereof and, accordingly, reference should be made to the appended claims, rather than to the foregoing specification, as indicating the scope of the invention.

What is claimed is:

1. A method of constructing at least one computer program that solves a problem, comprising the steps of:
defining a set of traits in which each trait characterizes a portion of a solution algorithm to the problem;
defining a programming interface for at least one of the traits;
providing an implementation for at least one of the defined programming interfaces;
specifying a subtrait associated with at least one of the traits or the implementations;
selecting a top-level trait that characterizes a solution to the problem;
selecting a top-level implementation for the top-level trait;
selecting an implementation for each subtrait required for the top-level trait or the top-level implementation;
recursively selecting an implementation for each subtrait associated with at least one of the traits or the implementations in order to construct a trait hierarchy that forms a computer program for solving the problem.

2. The computer program constructing method according to claim 1, wherein the at least one trait comprises a plurality of traits.

3. The computer program constructing method according to claim 2, wherein a computer programming interface is defined for each of the traits.

4. The computer program constructing method according to claim 3, wherein an implementation is provided for each computer programming interface.

5. The computer program constructing method according to claim 1, wherein the subtrait comprises a plurality of subtraits.

6. The computer program constructing method according to claim 4, wherein the subtrait comprises a plurality of subtraits.

7. The computer program constructing method according to claim 1, wherein the top-level trait comprises a plurality of top-level traits.

8. The computer program constructing method according to claim 6, wherein the top-level trait comprises a plurality of top-level traits.

9. The computer program constructing method according to claim 1, wherein the top-level trait comprises a plurality of top-level traits.

10. The computer program constructing method according to claim 5, wherein the subtraits are associated with at least one of the traits, the implementation, or both.

11. The computer program constructing method according to claim 1, wherein the subtrait is one of the defined set of traits.

12. The computer program constructing method according to claim 6, wherein the subtraits associated with the traits, the implementation, or both.

13. The computer program constructing method according to claim 4, further comprising the steps of:
implementing an evaluation module that executes a constructed computer program in order to determine its effectiveness in solving the problem; and
applying an optimization technique that carries out the steps of claim 1 to generate at least one computer program that solves the problem, and that uses feedback from the evaluation module to generate at least one additional computer program that better solves the problem.

14. The computer program constructing method according to claim 13, wherein the optimization technique is selected from the group consisting of simulated annealing, an evolutionary algorithm, and a particle swarm optimization.

15. The computer program constructing method according to claim 13, further comprising the steps of:
allowing a user to interactively choose which trait implementations are favored or excluded at each point in each alternative computer program created by the optimization technique.

16. The computer program constructing method according to claim 1, further comprising the steps of:
defining at least one self-describing method as part of the trait implementation's interface that provides information about the trait implementation or its associated subtrait; and
implementing the at least one self-describing method as part of the trait implementation.

17. The computer program constructing method according to claim 16, further comprising the steps of:
using the at least one self-describing method in a user interface to provide descriptions and other detailed information about the constructed solution algorithm.

18. The computer program constructing method according to claim 16, further comprising the steps of:
using the at least one self-describing method in an optimization technique to assist in the creation of alternative computer programs.

19. The computer program constructing method according to claim 16, further comprising the steps of:
using the at least one self-describing method in an interactive development environment to assist a user in assembling computer programs.

20. A system for constructing at least one computer program that solves a problem, comprising:
means for defining a set of traits in which each trait characterizes a portion of a solution algorithm to the problem;
means for defining a programming interface for at least one of the traits;
an implementation for at least one of the defined programming interfaces;
a subtrait associated with at least one of the traits or the implementations;
means for selecting a top-level trait that characterizes a solution to the problem;
means for selecting a top-level implementation for the top-level trait;
means for selecting an implementation for each subtrait required for the top-level trait or the top-level implementation;
means for recursively selecting an implementation for each subtrait associated with at least one of the traits or the implementations in order to construct a trait hierarchy that forms a computer program for solving the problem.
